(19) United States
(12) Patent Application Publication
(10) Pub. No.: US 2024/0348581 A1
(43) Pub. Date: Oct. 17, 2024

(54) DISTINCTION DEVICE, DISTINCTION METHOD, AND DISTINCTION PROGRAM

(71) Applicant: Nippon Telegraph and Telephone Corporation, Tokyo (JP)

(72) Inventors: Takeaki NISHIOKA, Musashino-shi, Tokyo (JP); Shohei KAMAMURA, Musashino-shi, Tokyo (JP); Yuhei HAYASHI, Musashino-shi, Tokyo (JP)

(21) Appl. No.: 18/685,407

(22) PCT Filed: Sep. 7, 2021
(86) PCT No.: PCT/JP2021/032917

§ 371 Date: Feb. 21, 2024

(51) Int. Cl. H04L 61/5007; H04L 61/4511

(52) U.S. Cl. CPC H04L 61/5007; H04L 61/4511

(57) ABSTRACT

A first collection unit (15a) stores an association between an IP address of the user terminal, a domain name, and an IP address of a communication destination server corresponding to the domain name in a name resolution information collection DB (14a) of a storage unit (14) using a name resolution packet between a user terminal and a DNS server. A second collection unit (15b) stores a correspondence among an IP address outside a capsule of a user terminal, an IP address inside the capsule, and an IP address of a communication destination server 3 in an inner-outer association DB (14b) of the storage unit (14) using header information outside the capsule of an encapsulated packet between the user terminal and the communication destination server and header information inside the capsule.

### TECHNICAL FIELD

The present invention relates to a discrimination device, a discrimination method, and a discrimination program.

### BACKGROUND ART

Conventionally, a domain name serving as a communication destination of traffic is discriminated by collecting a name resolution packet such as a DNS query/response for traffic transferred on a network, and analysis is performed in units of applications/services. Here, in order to identify the application/service of the traffic, information of a set of the address information of the user terminal, the address information of the communication destination server, and the communication destination domain name is required.

In addition, in recent years, in a user's home environment, name resolution in a dual stack environment capable of supporting both IPV4 communication and IPV6 communication has often been performed by IPV6 communication.

### CITATION LIST

### Non Patent Literature

Non Patent Literature 1: “Genie Analytics Deep Trace”, [online], Genie, [retrieved on Jul. 27, 2021], the Internet <URL: https://www.genie-networks.com/genieanalytics-deep-trace/>
Non Patent Literature 2: “Arbor Sightline”, [online], NETSCOUT, [retrieved on Jul. 27, 2021], the Internet <URL: https://www.netscout.com/product/arbor-sightline>
Non Patent Literature 3: “InfiniStreamNG Smart Visibility”, [online], NETSCOUT, [retrieved on Jul. 27, 2021], the Internet <URL: https://www.netscout.com/product/isng-platform>
Non Patent Literature 4: “Deepfield”, [online], NOKIA, [retrieved on Jul. 27, 2021], the Internet <URL: https://www.nokia.com/networks/solutions/deepfield/>
Non Patent Literature 5: “Mapping of Address and Port with Encapsulation (MAP-E)”, [online], rfc7597, [retrieved on Jul. 27, 2021], the Internet <URL: https://www.rfc-editor.org/rfc/rfc7597.html>
Non Patent Literature 6: “Dual-Stack Lite Broadband Deployments Following IPV4 Exhaustion”, [online], rfc6333, [retrieved on Jul. 27, 2021], the Internet <URL: https://www.rfc-editor.org/rfc/rfc6333.html>

### SUMMARY OF INVENTION

### Technical Problem

However, in the related art, it is difficult to analyze traffic in a dual stack environment in units of applications/services. That is, since it is difficult to match the name resolution result performed in the IPV6 communication with the actual communication performed in the IPV4 communication, the domain name cannot be discriminated, and analysis in units of applications/services is difficult. For example, in a case where name resolution is performed using an IP address of an IPV6 in a dual stack environment, an ISP side in which the IPV6 header is decapsulated cannot obtain information of a set of address information of a user terminal, address information of a communication destination server, and a communication destination domain name, and thus cannot identify an application/service.

The present invention has been made in view of the above, and an object thereof is to analyze traffic in a dual stack environment in units of applications/services.

### Solution to Problem

In order to solve the above-described problems and achieve the object, a discrimination device according to the present invention includes a first collection unit that stores an association between an IP address of a user terminal, a domain name, and an IP address of a communication destination server corresponding to the domain name in a storage unit using a name resolution packet between the user terminal and a domain name system (DNS) server, and a second collection unit that stores a correspondence among an IP address outside a capsule of the user terminal, an IP address inside the capsule, and an IP address of a communication destination server in the storage unit using header information outside the capsule of an encapsulated packet between the user terminal and the communication destination server and header information inside the capsule.

### Advantageous Effects of Invention

According to the present invention, it is possible to analyze traffic in a dual stack environment in units of applications/services.

### BRIEF DESCRIPTION OF DRAWINGS

FIG. 1 is a diagram illustrating an overview of a discrimination device.

FIG. 2 is a diagram illustrating an overview of the discrimination device.

FIG. 3 is a diagram illustrating an overview of the discrimination device.

FIG. 4 is a schematic diagram illustrating a schematic configuration of the discrimination device.

FIG. 5 is a flowchart illustrating a discrimination processing procedure.

FIG. 6 is a diagram illustrating a computer that executes a discrimination program.

### DESCRIPTION OF EMBODIMENTS

Hereinafter, an embodiment of the present invention will be described in detail with reference to the drawings. Note that the present invention is not limited by this embodiment. Further, in the description of the drawings, the same portions are denoted by the same reference numerals.

### [Outline of Discrimination Device]

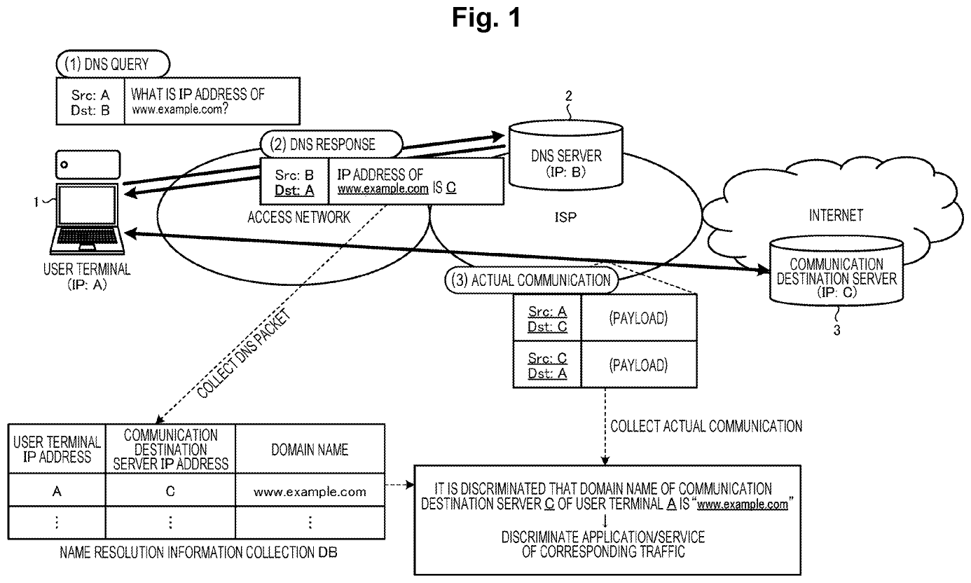

First, an outline of a discrimination device according to the present embodiment will be described with reference to FIGS. 1 to 3. FIGS. 1 to 3 are diagrams for illustrating an outline of a discrimination device. As illustrated in FIG. 1, conventionally, in communication on the Internet, name resolution is performed by a domain name system (DNS) before actual communication of a service itself. Specifically, in order to identify the application/service of the traffic, information of a set of the address information of the user terminal, the address information of the communication destination server, and the communication destination domain name is required.

In the example illustrated in FIG. 1, a user terminal 1 with an IP address: A transmits a DNS query to a DNS server 2 with an IP address: B, and acquires a DNS response notifying that the IP address is C with the domain name “www.example.com”. Then, the name resolution packet (DNS query/DNS response) is collected, and the name resolution information collection DB in which the user terminal 1 with the IP address: A and the domain name “www.example.com” of a communication destination server 3 with the IP address: C are associated with each other is constructed. In addition, the payload of the actual communication between the IP address: A and the IP address: C can be identified as the packet of the application/service having the domain name “www.example.com”, collected, and analyzed.

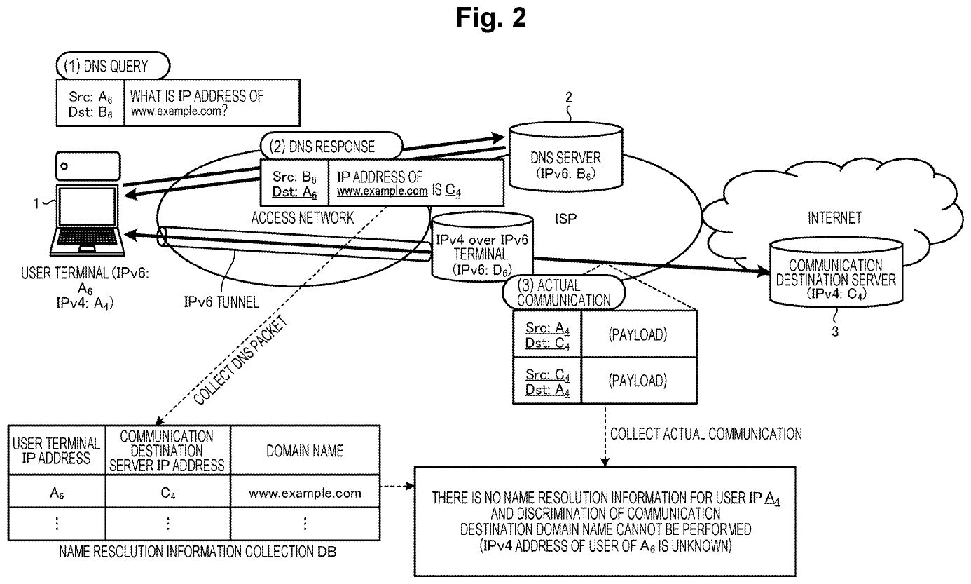

On the other hand, as illustrated in FIG. 2, in the dual stack environment capable of supporting both the IPv4 communication and the IPV6 communication, in a case where the protocols of the name resolution packet and the actual communication do not match, the domain name of the communication destination of the actual communication cannot be discriminated. For example, in a case where name resolution is performed using an IP address of an IPV6 in a dual stack environment, an ISP side in which the IPV6 header is decapsulated cannot obtain information of a set of address information of a user terminal, address information of a communication destination server, and a communication destination domain name, and thus cannot identify an application/service.

In the example illustrated in FIG. 2, the name resolution packet is performed by the IPV6 communication, and the actual communication is performed by the IPV4 communication. That is, the user terminal 1 with the IP address A6 of the IPV6 transmits a DNS query to the DNS server 2 with an IP address B6 of the IPV6, and acquires a DNS response notifying that an IP address is C4 of an IPV4 with the domain name “www.example.com”. Then, the name resolution information collection DB in which the domain name “www.example.com” of the communication destination server 3 with an IP address: A6 of an IPV6 and the IP address C4 of the IPV4 is associated is constructed. In addition, the user terminal 1 performs actual communication with the IP address: C4 of the IPV4 at the IP address: A4 of the IPV4. Therefore, in the information in the name resolution information collection DB, the domain name of the actual communication between the IP address A4 of the IPv4 and the IP address C4 of the IPV4 cannot be discriminated.

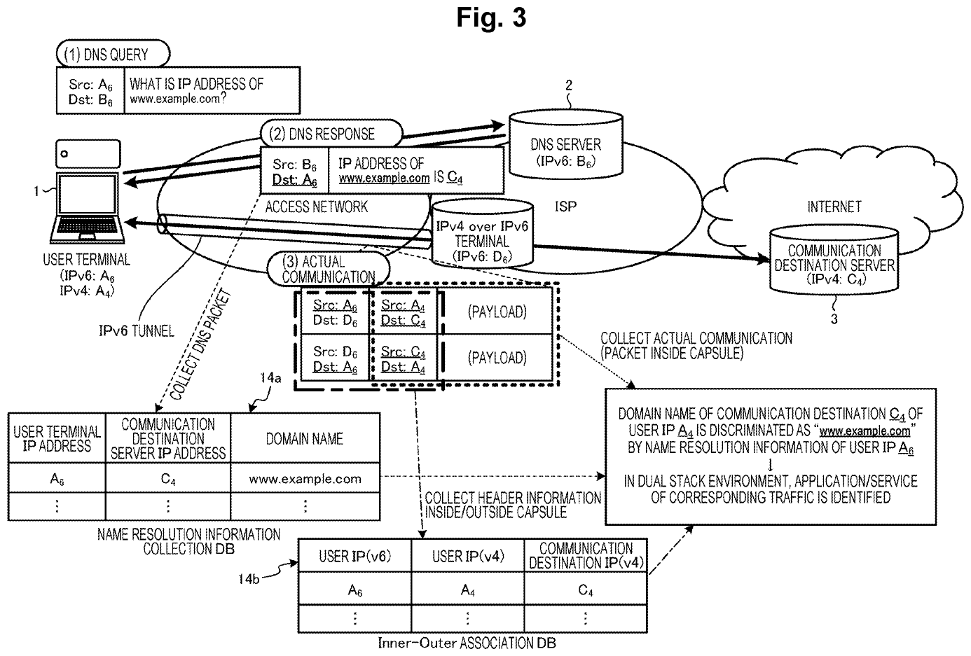

Therefore, as illustrated in FIG. 3, the discrimination device of the present embodiment collects header information inside and outside the capsule in an access network to acquire information of a set of the address information of the user terminal, the address information of the communication destination server, and the communication destination domain name, and can identify the application/service.

Specifically, similarly to FIG. 2, the discrimination device stores the source IPV6 address and the name resolution content in a name resolution information collection DB 14a using the name resolution packet. In addition, for the actual communication packet of IPV4 over IPv6, header information on the inside/outside of the capsule of the encapsulation packet in the tunnel section of IPV6 is collected and stored in an inner-outer association DB 14b. In the example illustrated in FIG. 3, the inner-outer association DB 14b is constructed by associating the IP address: A6 of the IPV6 of the user terminal 1, the IP address: A4 of the IPV4, and the IP address: C4 of the IPV4 of the communication destination server 3.

Then, by referring to the name resolution information collection DB 14a and the inner-outer association DB 14b, the discrimination device can discriminate the domain name “www.example.com” for actual communication between the IP address: A4 of the IPV4 and the IP address: C4 of the IPV4 inside the capsule.

### [Configuration of Discrimination Device]

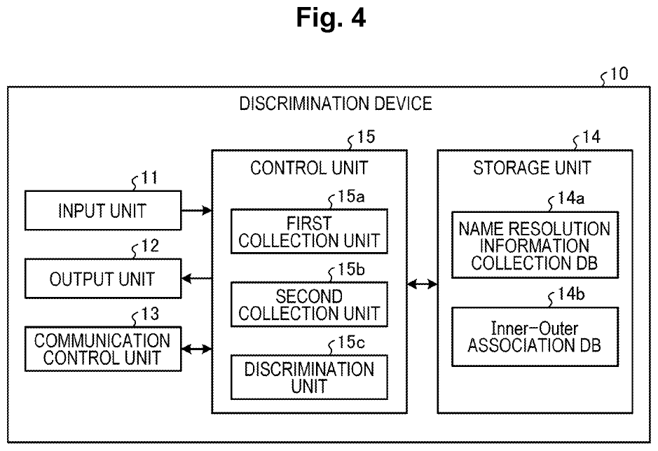

FIG. 4 is a schematic diagram illustrating a schematic configuration of the discrimination device 10. As illustrated in FIG. 4 as an example, the discrimination device 10 is realized by a general-purpose computer such as a personal computer and includes a communication control unit 13, a storage unit 14, and a control unit 15.

The communication control unit 13 is implemented by a network interface card (NIC) or the like and controls communication between an external device such as a server and the control unit 15 via a network. For example, the communication control unit 13 controls communication between the control unit 15 and the user terminal 1, the DNS server 2, the communication destination server 3, and the like which are targets of discrimination processing to be described later.

The storage unit 14 is realized by a semiconductor memory element such as a random access memory (RAM) or a flash memory, or a storage device such as a hard disk or an optical disc, and stores the name resolution information collection DB 14a, the inner-outer association DB 14b, and the like used for discrimination processing to be described later. The storage unit 14 may communicate with the control unit 15 via the communication control unit 13.

As illustrated in FIG. 3, the name resolution information collection DB 14a is information in which the IP address of the user terminal 1, the domain name, and the IP address of the communication destination server 3 corresponding to the domain name are associated with each other. In the example illustrated in FIG. 3, the IP address: A6 of the IPV6 of the user terminal 1, the IP address: C4 of the IPV4 of the communication destination server 3, and the domain name “www.example.com” of the communication destination server 3 are associated with each other.

Further, as illustrated in FIG. 3, the inner-outer association DB 14b is information in which the IP address outside the capsule of the user terminal 1, the IP address inside the capsule, and the IP address of the communication destination server 3 are associated with each other in the header information of the encapsulated packet. In the example illustrated in FIG. 3, the IP address: A6 of the IPV6 of the user terminal 1, the IP address: A4 of the IPV4, and the IP address: C4 of the IPV4 of the communication destination server 3 are associated with each other in the header information inside/outside the capsule of the encapsulation packet in the tunnel section of the IPV6.

The control unit 15 is realized with a central processing unit (CPU), a network processor (NP), a field programmable gate array (FPGA), or the like and executes a processing program stored in the memory. As a result, as illustrated in FIG. 4, the control unit 15 functions as a first collection unit 15a, a second collection unit 15b, and a discrimination unit 15c. Each of these functional units may be implemented in different hardware. For example, the discrimination unit 15c may be implemented in hardware different from the first collection unit 15a and the second collection unit 15b. The control unit 15 may also include other functional units. Furthermore, the discrimination device 10 may be implemented in the user terminal 1.

The first collection unit 15a uses the name resolution packet between the user terminal 1 and the DNS server 2 to store, in the storage unit 14, an association between the IP address of the user terminal 1, the domain name, and the IP address of the communication destination server 3 corresponding to the domain name.

Specifically, the first collection unit 15a collects a DNS query and a DNS response as a name resolution packet between the user terminal 1 and the DNS server 2. Then, as illustrated in FIG. 3, the first collection unit 15a stores the IP address of the user terminal 1, the domain name, and the IP address of the communication destination server 3 corresponding to the domain name in the name resolution information collection DB 14a in association with each other.

The second collection unit 15b stores, in the storage unit 14, a correspondence among the IP address outside the capsule of the user terminal 1, the IP address inside the capsule, and the IP address of the communication destination server 3 by using the header information outside the capsule of the encapsulated packet between the user terminal 1 and the communication destination server 3 and the header information inside the capsule.

Specifically, the second collection unit 15b collects header information outside the capsule and header information inside the capsule of the encapsulated packet between the user terminal 1 and the communication destination server 3. Then, as illustrated in FIG. 3, the second collection unit 15b stores the IP address outside the capsule of the user terminal 1, the IP address inside the capsule, and the IP address of the communication destination server 3 in the inner-outer association DB 14b in association with each other.

As a result, the discrimination device 10 can discriminate the domain name corresponding to the IP address of the packet inside the capsule by referring to the name resolution information collection DB 14a and the inner-outer association DB 14b.

Here, for example, the DNS server 2 communicates in the IPV6, and the communication destination server 3 communicates in the IPV4. Therefore, the discrimination device 10 refers to the name resolution information collection DB 14a illustrated in FIG. 3 and obtains association of the IP address: A6 of the IPV6 of the user terminal 1, the IP address: C4 of the IPV4 of the communication destination server 3, and the domain name “www.example.com” of the communication destination server 3. In addition, the discrimination device 10 refers to the inner-outer association DB 14b and obtains association of the IP address: A6 of the IPV6 of the user terminal 1, the IP address: A4 of the IPV4, and the IP address: C4 of the IPV4 of the communication destination server 3. As a result, the discrimination device 10 can discriminate the domain name of the packet between the IP address: A4 of the IPV4 inside the capsule and the IP address: C4 of the IPV4 of the communication destination server 3.

The discrimination unit 15c discriminates the domain name of the packet inside the capsule between the user terminal 1 and the communication destination server 3 with reference to the storage unit 14.

Specifically, the discrimination unit 15c extracts a packet inside the capsule between the user terminal 1 and the communication destination server 3 as the analysis target traffic. Then, as described above, the discrimination unit 15c discriminates the domain name corresponding to the IP address of the packet inside the capsule by referring to the name resolution information collection DB 14a and the inner-outer association DB 14b. As a result, the discrimination device 10 can discriminate the domain name of the actual communication packet and analyze the traffic in the dual stack environment in units of applications/services.

### [Discrimination Processing]

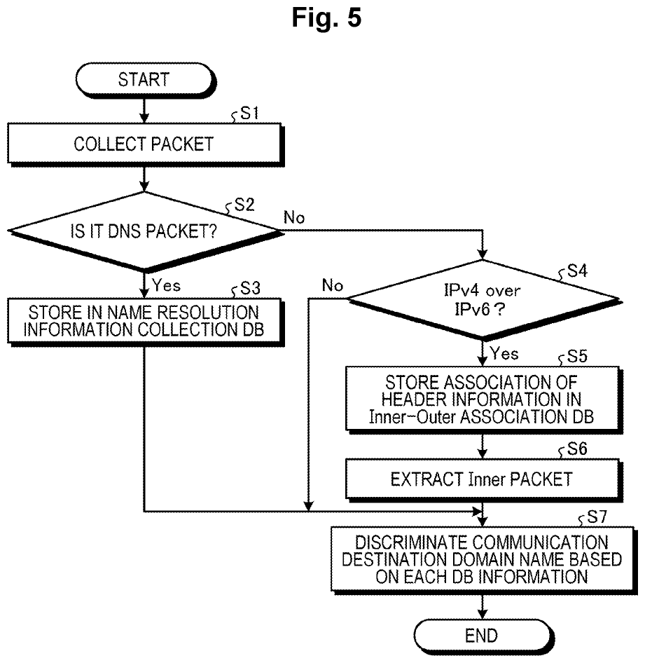

Next, discrimination processing by the discrimination device 10 according to the present embodiment will be described with reference to FIG. 5. FIG. 5 is a flowchart illustrating a discrimination processing procedure. The flowchart of FIG. 5 is started, for example, at a timing when the start of the process is instructed.

First, in a case where the collected packet is a DNS packet (Step S1-Step S2, Yes), the first collection unit 15a stores the IP address of the user terminal 1, the domain name, and the IP address of the communication destination server 3 corresponding to the domain name in the name resolution information collection DB 14a in association with each other (step S3).

In addition, in a case where the collected packet is an encapsulated packet such as IPV4 over IPv6 (Step S2, No-Step S4, Yes), the second collection unit 15b stores the IP address outside the capsule of the user terminal 1, the IP address inside the capsule, and the IP address of the communication destination server 3 in the inner-outer association DB 14b in association with each other (step S5).

In addition, the discrimination unit 15c extracts a packet inside the capsule between the user terminal 1 and the communication destination server 3 as the analysis target traffic (step S6). Then, the discrimination unit 15c discriminates the domain name corresponding to the IP address of the packet inside the capsule by referring to the name resolution information collection DB 14a and the inner-outer association DB 14b (step S7).

In addition, in a case where the collected packet is not an encapsulated packet such as IPv4 over IPv6 (Step S2, No-Step S4, No), the discrimination unit 15c refers to the name resolution information collection DB 14a and discriminates a domain name of a packet of actual communication (step S7). As a result, a series of discrimination processing ends.

As described above, in the discrimination device 10, the first collection unit 15a uses the name resolution packet between the user terminal 1 and the DNS server 2 to store, in the storage unit 14, an association between the IP address of the user terminal 1, the domain name, and the IP address of the communication destination server 3 corresponding to the domain name. In addition, the second collection unit 15b stores, in the storage unit 14, a correspondence among the IP address outside the capsule of the user terminal 1, the IP address inside the capsule, and the IP address of the communication destination server 3 by using the header information outside the capsule of the encapsulated packet between the user terminal 1 and the communication destination server 3 and the header information inside the capsule.

As a result, the discrimination device 10 can discriminate the domain name corresponding to the IP address of the packet inside the capsule by referring to the name resolution information collection DB 14a and the inner-outer association DB 14b. Accordingly, the discrimination device 10 can discriminate the domain name of the actual communication packet and analyze the traffic in the dual stack environment in units of applications/services.

Specifically, the DNS server 2 communicates in the IPV6, and the communication destination server 3 communicates in the IPV4. Accordingly, the discrimination device 10 can discriminate the domain name of the packet between the IP address of the IPV4 inside the capsule and the IP address of the IPV4 of the communication destination server 3.

In addition, the discrimination unit 15c discriminates the domain name of the packet inside the capsule between the user terminal 1 and the communication destination server 3 with reference to the storage unit 14. As a result, the discrimination device 10 can extract the real communication traffic in the dual stack environment as an analysis target, discriminate the domain name of the real communication packet, and analyze the real communication packet in units of applications/services.

### [Program]

It is also possible to produce a program that describes the processing executed by the discrimination device 10 according to the above embodiment in a computer executable language. In an embodiment, the discrimination device 10 can be implemented by installing a discrimination program that executes the foregoing discrimination process as packaged software or online software in a desired computer. For example, by causing an information processing device to perform the discrimination program, the information processing device can be caused to function as the discrimination device 10. In addition, the information processing apparatus includes a mobile communication terminal such as a smartphone, a mobile phone, or a personal handyphone system (PHS) and a slate terminal such as a personal digital assistant (PDA). Further, the functions of the discrimination device 10 may be mounted on a cloud server.

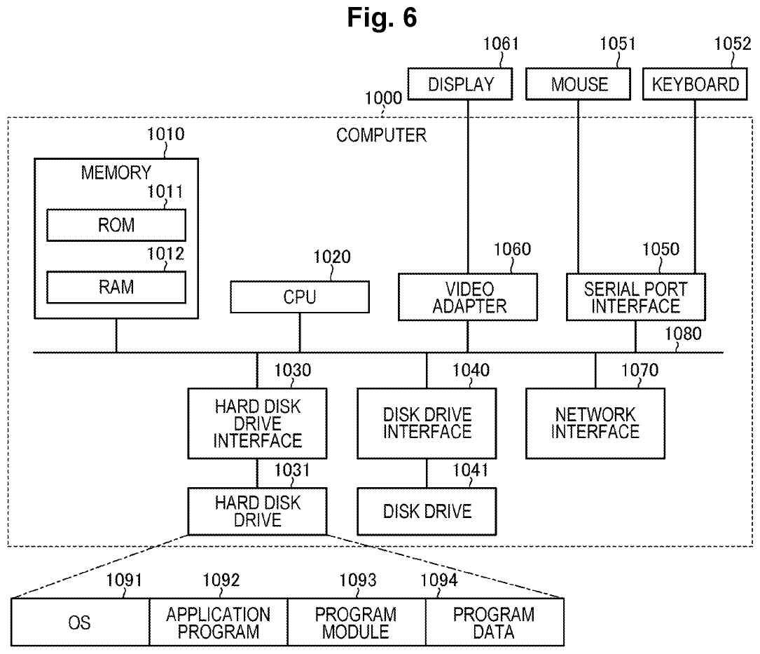

FIG. 6 is a diagram illustrating an example of a computer that executes a discrimination program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read-only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

The discrimination program is stored in the hard disk drive 1031 as the program module 1093 in which commands to be executed by the computer 1000, for example, are described. Specifically, the program module 1093 in which each type of processing performed by the discrimination device 10 described in the above embodiment is written is stored in the hard disk drive 1031.

Data used in information processing performed by the discrimination program is stored as the program data 1094 in, for example, the hard disk drive 1031. The CPU 1020 reads, into the RAM 1012, the program module 1093 and the program data 1094 stored in the hard disk drive 1031 as necessary and executes each procedure described above.

The program module 1093 and the program data 1094 related to the discrimination program are not limited to being stored in the hard disk drive 1031, and may be stored in, for example, a removable storage medium and read by the CPU 1020 via the disk drive 1041 or the like. Alternatively, the program module 1093 and the program data 1094 related to the discrimination program may be stored in another computer connected via a network such as a local area network (LAN) or a wide area network (WAN) and may be read by the CPU 1020 via the network interface 1070.

Although the embodiments to which the invention made by the present inventor is applied have been described above, the present invention is not limited by the description and the drawings which are parts of the disclosure of the embodiment of the present invention. In other words, other embodiments, examples, operational techniques, and the like made by those skilled in the art or the like on the basis of the present embodiment are all included in the scope of the present invention.

### REFERENCE SIGNS LIST

1 User terminal
2 DNS server
3 Communication destination server
10 Discrimination device
13 Communication control unit
14 Storage unit
14a Name resolution information collection DB
14b Inner-Outer association DB
15 Control unit
15a First collection unit
15b Second collection unit
15c Discrimination unit

1. A discrimination device comprising one or more processors configured to:
store an association between an IP address of a user terminal, a domain name, and an IP address of a communication destination server corresponding to the domain name in a storage unit using a name resolution packet between the user terminal and a domain name system (DNS) server; and
store a correspondence among an IP address outside a capsule of the user terminal, an IP address inside the capsule, and an IP address of a communication destination server in the storage unit using header information outside the capsule of an encapsulated packet between the user terminal and the communication destination server and header information inside the capsule.

2. The discrimination device according to claim 1, wherein the one or more processors are further configured to:
discriminate a domain name of a packet inside a capsule between the user terminal and the communication destination server with reference to the storage unit.

3. The discrimination device according to claim 1, wherein the DNS server communicates in IPV6, and the communication destination server communicates in IPV4.

4. A discrimination method executed by a discrimination device, the method comprising:
storing an association between an IP address of a user terminal, a domain name, and an IP address of a communication destination server corresponding to the domain name in a storage unit using a name resolution packet between the user terminal and a domain name system (DNS) server; and
storing a correspondence among an IP address outside a capsule of the user terminal, an IP address inside the capsule, and an IP address of a communication destination server in the storage unit using header information outside the capsule of an encapsulated packet between the user terminal and the communication destination server and header information inside the capsule.

5. A non-transitory computer readable medium storing one or more instructions causing a computer to execute:
storing an association between an IP address of a user terminal, a domain name, and an IP address of a communication destination server corresponding to the domain name in a storage unit using a name resolution packet between the user terminal and a domain name system (DNS) server; and
storing a correspondence among an IP address outside a capsule of the user terminal, an IP address inside the capsule, and an IP address of a communication destination server in the storage unit using header information outside the capsule of an encapsulated packet between the user terminal and the communication destination server and header information inside the capsule.
